(19) United States
(12) Patent Application Publication
(10) Pub. No.: US 2017/0337197 A1
(43) Pub. Date: Nov. 23, 2017

(54) RULE MANAGEMENT SYSTEM AND METHOD

(71) Applicant: SAMSUNG SDS CO., LTD., Seoul (KR)

(72) Inventors: Yeon-Su JUNG, Seoul (KR); Sung-Il KIM, Seoul (KR); Tae-Hwan JEONG, Seoul (KR)

(73) Assignee: SAMSUNG SDS CO., LTD., Seoul (KR)

(21) Appl. No.: 15/597,710

(22) Filed: May 17, 2017

(30) Foreign Application Priority Data
May 17, 2016 (KR) 10-2016-0060374

(51) Int. Cl. G06F 17/30; G06N 5/02; G06N 5/04

(52) U.S. Cl. CPC G06F 17/3048; G06N 5/04; G06F 17/30339; G06N 5/025

(57) ABSTRACT

A rule management system and method are provided. The rule management system according to an embodiment of the present disclosure includes a processor configured to implement: a rule engine configured to perform decision-making based on a rule; and a data service engine configured to connect to a database (DB) of a legacy system, determine data stored in the DB to be cached by analyzing the rule, and cache the determined data, wherein the rule engine is further configured to perform the decision-making using data cached in the data service engine.

### CROSS-REFERENCE TO RELATED APPLICATION

This application claims priority to and the benefit of Korean Patent Application No. 10-2016-0060374, filed on May 17, 2016, the disclosure of which is incorporated herein by reference in its entirety.

### BACKGROUND

### 1. Field

The present disclosure relates to a technology for efficiently performing a rule process.

### 2. Discussion of Related Art

A rule engine refers to an automation system, technology, or solution that derives, standardizes, and manages complex task rules used in corporate decision-making or frequently changeable processes. In general, the rule engine performs decision-making in conjunction with a legacy system. The legacy system is a system that performs task processing in conjunction with the rule engine, and can be developed based on past platforms, programming languages, technologies, and the like.

However, conventionally, when data stored in a database (DB) of the legacy system is needed during a decision-making process of the rule engine, the rule engine only has to access the DB through a legacy server. Specifically, conventionally, there has been a problem in that it is troublesome to transmit a query to the rule engine by retrieving the DB in units of cases from the server of the legacy system and to transmit the result to the DB of the legacy system again after receiving the result from the rule engine. Therefore, according to the related art, whenever a DB access is required in the rule engine, there is a problem that an excessive transaction occurs due to a constraint in which the DB access must occur through the legacy system. Particularly, according to the related art, a bottleneck phenomenon occurs in the legacy system because DB access, data collection, and data transfer are repeatedly performed according to the number of rules, so that complexity increases due to execution of the rules.

### SUMMARY

The present disclosure is directed to a rule management system and method which may cache data in a data service engine and perform decision-making using the data cached in the data service engine when a corresponding rule is executed, so that advantages of multi-threading may be maximized and the speed of rule processing may be dramatically improved.

According to an aspect of the present disclosure, there is provided a rule management system including: a processor configured to implement: a rule engine configured to perform decision-making based on a rule; and a data service engine configured to connect to a database (DB) of a legacy system, determine data stored in the DB to be cached by analyzing the rule, and cache the determined data, wherein the rule engine is further configured to perform the decision-making using data cached in the data service engine.

Here, the data service engine may be further configured to determine the data stored in the DB to be cached to minimize costs required for execution of the rule.

Also, the rule may be one of a plurality of rules, and the data service engine may be further configured to determine the data stored in the DB to be cached based on a frequency of execution for each of the plurality of rules.

Also, the data service engine may be further configured to increase a probability that data related to a corresponding rule of the plurality of rules is to be cached in the data service engine as the frequency of execution increases, and reduce the probability that data related to a corresponding rule is to be cached in the data service engine as the frequency of execution decreases.

Also, the data service engine may be further configured to determine a cache priority for each table to which the data belongs, and determine the data stored in the DB to be cached in the data service engine according to the determined cache priority for each table to which the data belongs.

Also, the cache priority for each table to which the data belongs may be determined based on at least one among a frequency or probability of access for each table, a data manipulation frequency for each table, a data size for each table, a size of a data repository of the data service engine, a number of times each of the plurality of rules is executed, an execution time of a query related to execution of the of the plurality of rules, an execution speed of the query, a number or cycle of calls of the query, and a bandwidth usage while the data service engine is connected to the DB.

Also, when there are a plurality of pieces of data to be cached, the data service engine may be further configured to cache a data area having a range covering all of a plurality of pieces of data to be cached.

According to another aspect of the present disclosure, there is provided a rule management method including: performing, by a rule engine, decision-making based on a rules; determining, by a data service engine connected to a DB of a legacy system, data stored in the DB to be cached by analyzing the rule; and caching the determined data, wherein the performing includes performing the decision-making using data cached in the data service engine.

Here, the determining may include determining the data stored in the DB to be cached to minimize costs required for execution of the rule.

Also, the determining may include determining the data stored in the DB to be cached based on a frequency of execution for each of the plurality of rules.

Also, the determining may include increasing a probability that data related to a corresponding rule is determined to be cached in the data service engine as the frequency of execution increases, and reducing the probability that data related to a corresponding rule is determined to be cached in the data service engine as the frequency of execution decreases.

Also, the determining may include determining a cache priority for each table to which the data belongs, and determining the data stored in the DB to be cached in the data service engine according to determine the cache priority for each table to which the data belongs.

Also, the cache priority for each table to which the data belongs may be determined based on at least one among a frequency or probability of access for each table, a data manipulation frequency for each table, a data size for each table, a size of a data repository of the data service engine, a number of times each of the plurality of rules is executed, an execution time of a query related to execution of the plurality of rules, an execution speed of the query, a number or cycle of calls of the query, and a bandwidth usage while the data service engine is connected to the DB.

Also, the caching may include caching a data area having a range covering all of plurality of pieces of data to be cached.

According to another aspect of the present disclosure, there is provided a non-transitory computer readable recording medium having embodied thereon a program, which when executed by a processor of a rule management system, causes the rule management system to execute a rule management method, the rule management method including: performing, by a rule engine, decision-making based on a rules; determining, by a data service engine connected to a DB of a legacy system, at least data stored in the DB to be cached by analyzing the rule; and caching the determined data, wherein the performing includes performing the decision-making using data cached in the data service engine.

Here, the determining may include determining the data stored in the DB to be cached to minimize costs required for execution of the rule.

Also, the determining may include determining the data stored in the DB to be cached based on a frequency of execution for each of the plurality of rules.

Also, the determining may include increasing a probability that data related to a corresponding rule is determined to be cached in the data service engine as the frequency of execution increases, and reducing the probability that data related to a corresponding rule is determined to be cached in the data service engine as the frequency of execution decreases.

Also, the determining may include determining a cache priority for each table to which the data belongs, and determining the data stored in the DB to be cached in the data service engine according to determine the cache priority for each table to which the data belongs.

Also, the cache priority for each table to which the data belongs may be determined based on at least one among a frequency or probability of access for each table, a data manipulation frequency for each table, a data size for each table, a size of a data repository of the data service engine, a number of times each of the plurality of rules is executed, an execution time of a query related to execution of the plurality of rules, an execution speed of the query, a number or cycle of calls of the query, and a bandwidth usage while the data service engine is connected to the DB.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating a detailed configuration of a rule management system according to an embodiment of the present disclosure;

FIG. 2 is a block diagram illustrating a detailed configuration of a data service engine according to an embodiment of the present disclosure;

FIG. 3 is a flowchart illustrating a process of executing a plurality of rules in a general rule engine;

FIG. 4 is a block diagram illustrating a time required for rule A of FIG. 3 to be executed in a general rule execution process;

FIG. 5 is a block diagram illustrating a time required for rule B of FIG. 3 to be executed in a general rule execution process;

FIG. 6 is an exemplary diagram illustrating a probability that a data service engine for each rule is used in a rule execution process according to an embodiment of the present disclosure;

FIG. 7 is an exemplary diagram for explaining a process of caching a part of data in order to minimize costs required for executing a rule in a data service engine;

FIG. 8 is an exemplary diagram for explaining a process of updating cached data according to a cache priority for each table in a data service engine;

FIG. 9 is an exemplary diagram for explaining a process of optimizing data cached in a data service engine;

FIG. 10 is a block diagram for illustrating and explaining a computing environment including a computing device suitable for use in exemplary embodiments;

FIG. 11 is a flowchart illustrating a data caching process in a data service engine according to an embodiment of the present disclosure; and

FIG. 12 is a flowchart for explaining a rule processing procedure according to an embodiment of the present disclosure.

### DETAILED DESCRIPTION OF EXEMPLARY EMBODIMENTS

Hereinafter, specific embodiments of the present disclosure will be described with reference to the accompanying drawings. The following detailed description is provided to assist a comprehensive understanding of the embodiments of the disclosure. However, this is merely an example and the present disclosure is not limited thereto. In describing embodiments of the present disclosure, detailed descriptions of well-known functions or constructions will be omitted so as not to obscure the gist of the present disclosure. Also, the following terms are defined in consideration of the functions of the present disclosure, and may be differently defined according to a user, the intention of an operator or custom. Therefore, the terms should be defined based on the overall contents of the specification. Terminologies used in the present specification are to describe the exemplary embodiments and not to limit the present disclosure. In the present specification, unless particularly described in the description, a singular form includes a plural form. “Comprises/includes” and/or “comprising/including” used in the specification does not exclude the presence or addition of at least one another constituent element, step, operation, and/or device with respect to the described constituent element, step, operation/or device.

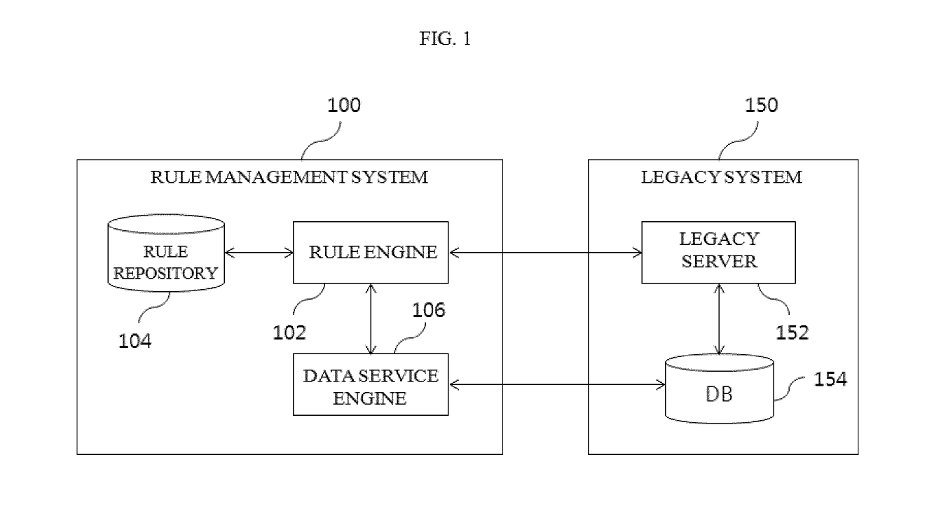

FIG. 1 is a block diagram illustrating a detailed configuration of a rule management system 100 according to an embodiment of the present disclosure. As illustrated in FIG. 1, the rule management system 100 according to an embodiment of the present disclosure is a system that performs decision-making in conjunction with a legacy system 150.

According to the present embodiments, decision-making refers to a process of selecting a specific behavior from a set of behaviors in the course of task processing. In addition, the task is a kind of office work that exists in corporations, organizations, public institutions, and the like, and may be, for example, emergency car routing related to assigning the route of an emergency car in hospitals, traffic optimization related to identifying patterns of traffic congestion to set an optimal route for public transportation in the road traffic service, and the like.

In addition, according to the present embodiments, the legacy system 150 is a system that performs task processing in conjunction with the rule management system 100, and can be developed based on past platforms, programming languages, technologies, and the like. As illustrated in FIG. 1, the legacy system 150 comprises a legacy server 152 and a database (DB) 154.

The legacy server 152 is a server for managing a processing logic for each task, and may be, for example, a hospital server, a bank server, an insurance company server, or the like. As an example, when the legacy server 152 is a hospital server, the hospital server may include a processing logic (process 1→process 2→process 3 . . . ) of a task for assigning the route of an emergency car, a processing logic (process 4→process 5 . . . ) of a task for registering a patient's hospital reservation, and the like, and perform task processing according to the processing logic. At this time, when a task that needs to derive decision-making based on a predefined rule is needed while the legacy server 152 performs the processing logic, the legacy server 152 may transmit a query to a rule engine 102. The rule engine 102 may perform decision-making based on the predefined rule according to the query, and transmit a decision-making result to the legacy server 152. The legacy server 152 may receive the decision-making result from the rule engine 102, and continuously perform the processing logic using the decision-making result. Here, the rule is used in a broad sense including all the rules, procedures, know-how, knowledge, and the like used in the decision-making process.

The DB 154 is a repository for storing data required in the decision-making process of the rule engine 102. The data stored in the DB 154 may be utilized as an input value or a reference value when the rule engine 102 performs decision-making.

Hereinafter, a detailed configuration of the rule management system 100 according to an embodiment of the present disclosure will be described in detail with reference to FIG. 1. As illustrated in FIG. 1, the rule management system 100 according to an embodiment of the present disclosure comprises the rule engine 102, a rule repository 104, and a data service engine 106.

The rule engine 102 is a module that performs decision-making based on one or more predefined rules. The rule engine 102 may be connected to the legacy server 152 via a network (not shown), and receive a query from the legacy server 152. The rule engine 102 may perform decision-making based on the predefined rule according to the query, and transmit a decision-making result to the legacy server 152. At this time, when the data stored in the DB 154 of the legacy system 150 is needed during a decision-making process of the rule engine 102 (that is, when the data stored in the DB 154 of the legacy system 150 is utilized as an input value or a reference value during a rule execution process), the rule engine 102 may perform decision-making using data cached in the data service engine 106 instead of accessing the DB 154 through the legacy server 152. As described below, the data service engine 106 may cache at least a part of the data stored in the DB 154 of the legacy system 150 and provide the cached data to the rule engine 102, and the rule engine 102 may perform decision-making using the cached data. Accordingly, it is possible to prevent the occurrence of an excessive transaction of the legacy system 150 and reduce a load of the legacy system 150, thereby preventing a bottleneck phenomenon that may occur when the corresponding rule is executed.

The rule repository 104 is a repository where one or more rules required for performing decision-making are stored. The rule engine 102 may execute the rule stored in the rule repository 104 according to a query received from the legacy server 152. For convenience of explanation, the rule repository 104 may be formed integrally with the rule engine 102 although it is shown as being a separate component from the rule engine 102 in FIG. 1.

The data service engine 106 is a module that fetches and caches at least a part of the data stored in the DB 154 of the legacy system 150 by analyzing the rule and provides the cached data to the rule engine 102 during performing decision-making of the rule engine 102. The data service engine 106 may include a data repository (not shown) that is not large in storage capacity, but has a fast read/write speed and is advantageous for random access, and a DBMS (database management system, not shown) that is used to manage the data repository. In addition, as illustrated in FIG. 1, the data service engine 106 may be connected to the DB 154 of the legacy system 150 via the network.

As described above, conventionally, when data stored in the DB of the legacy system is needed during a decision-making process of the rule engine, the rule engine only has to access the DB through the legacy server, and in this process, there is a problem that an excessive transaction occurs. In order to solve the problems of the related art, according to embodiments of the present disclosure, at least a part of the data stored in the DB 154 of the legacy system 150 may be cached in the data service engine 106 in advance, and then the data cached in the data service engine 106 may be used during the decision-making process of the rule engine 102.

However, in general, there are a number of rules in the rule repository 104, and data required for execution of each rule, the number and type of tables to which the data belongs, and the like may vary. In addition, since the capacity of the data repository of the data service engine 106 is not large, the size of the data stored in the data service engine 106 is also limited.

Accordingly, the data service engine 106 may cache a part of the data stored in the DB 154 so as to minimize costs required for the execution of the rule, and determine a cache priority for each table to which the data belongs so that the data may be cached according to the priority.

Specifically, the data service engine 106 may determine the data cached in the data service engine 106 in consideration of the frequency of execution for each rule. Here, the frequency of execution for each rule may be, for example, the number of times or probability that each rule is executed in the rule engine 102, the number of times or probability that the data service engine 106 for each rule is used during a rule execution process, or the like. At this time, the data service engine 106 may increase the probability that data related to the corresponding rule is cached in the data service engine 106 as the frequency of execution increases, and reduce the probability that data related to the corresponding rule is cached in the data service engine 106 as the frequency of execution decreases.

As an example, the data service engine 106 may increase the probability that data related to the corresponding rule is cached in the data service engine 106 as the number of times the corresponding rule is executed in the rule engine 102 increases, and reduce the probability that data related to the corresponding rule is cached in the data service engine 106 as the number of times the corresponding rule is executed in the rule engine 102 decreases.

As another example, the data service engine 106 may increase the probability that data related to the corresponding rule is cached in the data service engine 106 as the probability that the data service engine 106 is used during the rule execution process increases, and reduce the probability that data related to the corresponding rule is cached in the data service engine 106 as the probability that the data service engine 106 is used during the rule execution process decreases. At this time, the probability that the data service engine 106 for each rule is used may be calculated as a ratio of the number of times the data service engine 106 is used when the corresponding rule is executed to the total number of times the data service engine 106 is used, as follows.

It is satisfied that

the probability that the data service engine 106 for each rule is used

=the number of times the data service engine 106 is used when the corresponding rule is executed/the total number of times the data service engine 106 is used.

For example, the probability that the data service engine 106 for each rule is used can be expressed as follows.

The probability that the data service engine 106 is used when rule 1 is executed=0.2

The probability that the data service engine 106 is used when rule 2 is executed=0

The probability that the data service engine 106 is used when rule 3 is executed=0

The probability that the data service engine 106 is used when rule 4 is executed=0.15

The probability that the data service engine 106 is used when rule 5 is executed=0.3

The probability that the data service engine 106 is used when rule 6 is executed=0

The probability that the data service engine 106 is used when rule 7 is executed=0.02

The probability that the data service engine 106 is used when rule 8 is executed=0

The probability that the data service engine 106 is used when rule 9 is executed=0.13

. . .

In the above example, it can be seen that the probability that the data service engine 106 is used when rule 1, rule 4, rule 5, and rule 9 are executed is relatively high. Thus, when data related to rule 1, rule 4, rule 5, and rule 9 is cached in the data service engine 106, costs required for the execution of the rule may be relatively minimized (because I/O to the DB 154 of the legacy system 150 is minimized). Accordingly, according to the embodiments of the present disclosure, the higher the probability that the data service engine 106 is used when the corresponding rule is executed, the higher the probability that data related to the corresponding rule is cached in the data service engine 106.

In addition, the data service engine 106 may determine a cache priority for each table to which data belongs, and determine the data cached in the data service engine 106 according to the cache priority. Here, the table is a unit of a data set, and a plurality of tables (e.g., table A, table B, table C, etc.) may be stored in the DB 154 of the legacy system 150. In addition, each table may contain different kinds of data. As an example, table A may contain patient data, table B may contain data on symptoms of illness, and table C may contain data on diagnosis and treatment of illness. According to the present embodiments, the cache priority may be determined in consideration of at least one of, for example, a frequency or probability of access for each table, a data manipulation frequency for each table, a data size for each table, a size of the data repository of the data service engine 106, the number of times each rule is executed, an execution time of a query related to the execution of the rule, an execution speed of the query, the number or cycle of calls of the query, and a bandwidth usage while the data service engine 106 is connected to the DB 154.

As an example, the data service engine 106 may provide required data to the rule engine 102 via the data service engine 106 instead of the DB 154 of the legacy system 150 when the corresponding rule is actually executed, by caching data of a table having the highest statistical probability of access as much as possible. Thus, according to the embodiments of the present disclosure, an execution time of the rule may be minimized and the processing capacity of the rule engine 102 per unit time may be maximized. Here, the probability of access for each table may be calculated as a ratio of the number of access query requests of the corresponding table to the number of access query requests of all the tables as shown below.

The probability of access for each table

=the number of access query requests of the corresponding table/the number of access query requests of all the tables

In addition, the data service engine 106 may determine a cache priority according to a data manipulation frequency of a table to be fetched and cached. A DML (data manipulation language) attribute of a table refers to a language attribute that performs operations such as selecting, inserting, updating, and deleting data of the table. When updating, inserting, or the like is frequently performed on data of the table to be fetched and cached, updating, inserting, or the like must be frequently performed on data of the data repository of the data service engine 106. This is because the data stored in the DB 154 of the legacy system 150 and the data cached in the data repository of the data service engine 106 must be synchronized with each other. In this case, there may arise a problem that the data service engine 106 cannot provide the corresponding data to the rule engine 102 during the synchronization time, and costs required for synchronization may exceed actual utility. Thus, the data service engine 106 may defer the cache priority of the table where a data manipulation frequency is relatively high to a subordinate.

In addition, the data service engine 106 may determine the cache priority in consideration of the size of data for each table and the size (or storage capacity) of the data repository of the data service engine 106. The size of the data repository of the data service engine 106 is limited, and the data size of each table may be different depending on the type of the table. Accordingly, the data service engine 106 may determine the cache priority by analyzing the size of the data repository at the time of caching and the data size for each table. For example, the data service engine 106 may defer the cache priority of the table having a relatively large data size to a subordinate.

In addition, the data service engine 106 may determine the cache priority in consideration of the number of times the rule is executed and the execution time of the query related to the execution of the rule. For example, the data service engine 106 may determine the cache priority of the table to which data related to the rule belongs as a priority (i.e., determine to preferentially cache the corresponding table in the data service engine 106) as the number of times the rule is executed X the execution time of the query related to the execution of the rule becomes larger. The execution time of the query may include an I/O time between the rule engine 102 and the legacy system 150, an execution time of a DBMS itself within the legacy system 150, and the like.

In addition, the data service engine 106 may determine the cache priority in consideration of an execution speed of the query, the number or cycle of calls of the query, a bandwidth usage while the data service engine 106 is connected to the DB 154, and the like. For example, the data service engine 106 may determine the cache priority of the table to which data related to the corresponding rule belongs as a priority, as the execution speed of the query is slower, the number of calls of the query is larger, the cycle of calls of the query is shorter, and the bandwidth usage while the data service engine 106 is connected to the DB 154 is larger.

In this manner, the data service engine 106 may analyze the rule executed in the rule engine 102 to calculate costs required for the execution of the rule, and cache a part of the data stored in the DB 154 so that the costs are minimized. The data service engine 106 may calculate the costs in consideration of, for example, the above-described frequency of execution for each rule, frequency of access of the table to which the data related to the corresponding rule belongs, data manipulation frequency of the table, and the like.

At this time, the cache priority may be optimized to which a processing capacity is maximized with respect to a time required to cache data. That is, when a table having a high cache priority is preferentially cached in the data service engine 106, the costs required for the execution of the rule may be reduced. However, the above-described various items used for determining the cache priority are merely examples, and are not limited to the above-described examples. The data service engine 106 may determine the cache priority in consideration of, for example, a network resource usage, a data processing speed of the DB 154, and the like. In addition, the data service engine 106 may determine the cache priority by combining at least some of the items, and at this time, assign a weight to some of the items.

In addition, when there are a plurality of pieces of data to be cached, the data service engine 106 may cache a data area having a range covering all of the plurality of pieces of data. As an example, when the data to be cached is a, b, and c, and a, b, and c respectively have a data area range of a=0<x<50, b=40<x<70, and c=20<x<100, the data service engine 106 may optimize the cached data area by fetching and caching the data area having the range covering all of the plurality of pieces of data, that is, a data area having a range of 0<x<100 at a time. This optimization technique may be applied to data that has been frequently used recently. When a request for data outside a range of the optimized data area is required, the rule engine 102 may directly access the DB 154 of the legacy system 150 to collect the data outside the range. The collected data may be used to recalculate the range of the data area.

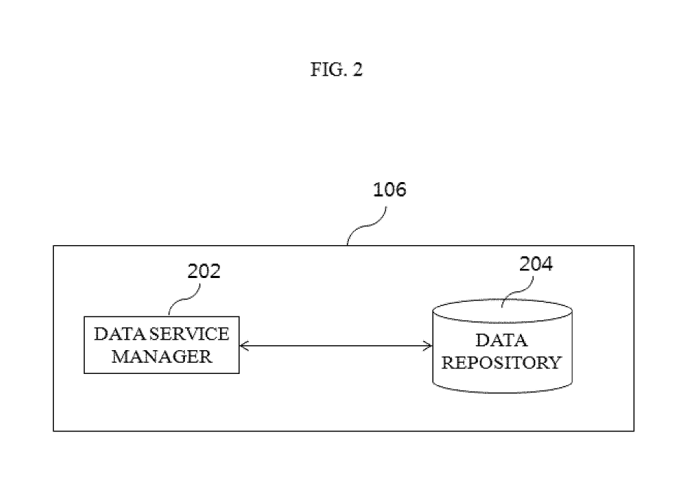

FIG. 2 is a block diagram illustrating a detailed configuration of the data service engine 106 according to an embodiment of the present disclosure. As illustrated in FIG. 2, the data service engine 106 according to an embodiment of the present disclosure comprises a data service manager 202 and a data repository 204.

The data service manager 202 determines data to be cached in the data repository 204. The data service manager 202 may determine a cache priority for each table to which data stored in the DB 154 belongs while caching a part of the data in the data repository 204 so as to minimize costs required for execution of a corresponding rule, thereby caching the data in the data repository 204 according to the determined cache priority.

As described above, the data service engine 106 may determine data cached in the data service engine 106 in consideration of a frequency of execution for each rule. Specifically, the data service engine 106 may increase a probability that data related to the corresponding rule is cached in the data service engine 106 as the frequency of execution increases, and reduce the probability that data related to the corresponding rule is cached in the data service engine 106 as the frequency of execution decreases.

In addition, the data service manager 202 may determine the cache priority for each table to which corresponding data belongs, and determine the data cached in the data repository 204 according to the cache priority. The cache priority may be determined in consideration of at least one of, for example, a frequency or probability of access for each table, a data manipulation frequency for each table, a data size for each table, a size of the data repository 204 of the data service engine 106, the number of times each rule is executed, an execution time of a query related to the execution of the rule, an execution speed of the query, the number or cycle of calls of the query, and a bandwidth usage while the data service engine 106 is connected to the DB 154.

The data repository 204 is a repository where data selected by the data service manager 202 is cached. The data repository 204 may be a repository that is not large in storage capacity, but has a fast read/write speed and is advantageous for random access, and may be managed by a DBMS. The data stored in the data repository 204 may be utilized as an input value or a reference value when the rule engine 102 performs decision-making.

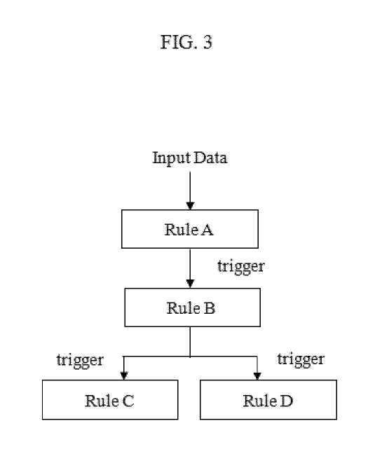

FIG. 3 is a flowchart illustrating a process of executing a plurality of rules in the general rule engine 102.

Referring to FIG. 3, when input data is input to the rule engine 102, rule A is executed. When rule A is completed, rule B having the same element as an output element of rule A may be executed. Similarly, when rule B is completed, rule C and rule D having the same element as an output element of rule B may be executed. In this manner, a plurality of rules may be sequentially executed according to the input of the input data, and rule B may be referred to as an association rule of rule A and rule C and rule D may be referred to as association rule of rule B.

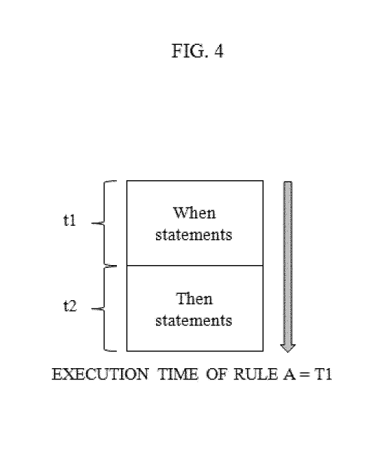

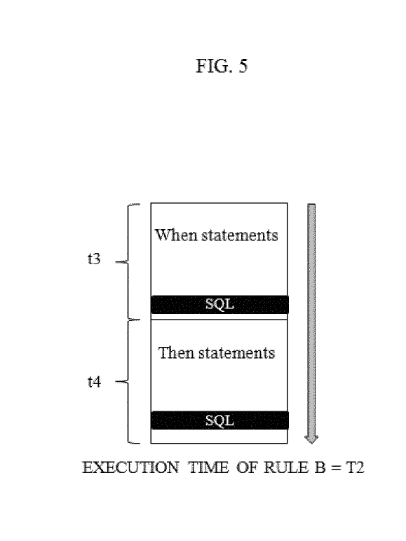

FIG. 4 is a block diagram illustrating a time required for rule A of FIG. 3 to be executed in a general rule execution process, and FIG. 5 is a block diagram illustrating a time required for rule B of FIG. 3 to be executed in a general rule execution process. Here, it is assumed that rule A is a rule that does not need to utilize data stored in the DB 154 of the legacy system 150 as an input value or a reference value and rule B is a rule that needs to utilize data stored in the DB 154 of the legacy system 150 as an input value or a reference value.

Referring to FIG. 4, rule A may be constituted of conditional statements (when statements) (for example, a case of 0<x<100) and output statements (then statements) (for example, y=50 output), and execution times of the conditional statements and the output statements may be t1 and t2, respectively. Accordingly, the execution time of rule A may be t1+t2.

Referring to FIG. 5, like rule A, rule B may be constituted of conditional statements and output statements. At this time, rule B may utilize the data stored in the DB 154 of the legacy system 150 as the input value or the reference value at the time of execution of the conditional statements and the output statements, so that a time required for connection of the DB 154 and data collection may be additionally required. Accordingly, the execution time of rule B may be t3+t4, which is larger than the execution time (t1+t2) of rule A.

In this manner, when the data stored in the DB 154 of the legacy system 150 is needed during a decision-making process of the rule engine 102, the rule engine 102 only has to access the DB 154 through the legacy server 152 in a general rule execution process, and an excessive transaction may occur in this process.

Accordingly, according to the embodiments of the present disclosure, at least a part of the data stored in the DB 154 of the legacy system 150 may be cached in the data service engine 106 in advance, and then the data cached in the data service engine 106 may be used during the decision-making process of the rule engine 102, so that the occurrence of the excessive transaction of the legacy system 150 may be prevented and a load of the legacy system 150 may be reduced, thereby preventing a bottleneck phenomenon that may occur when the corresponding rule is executed.

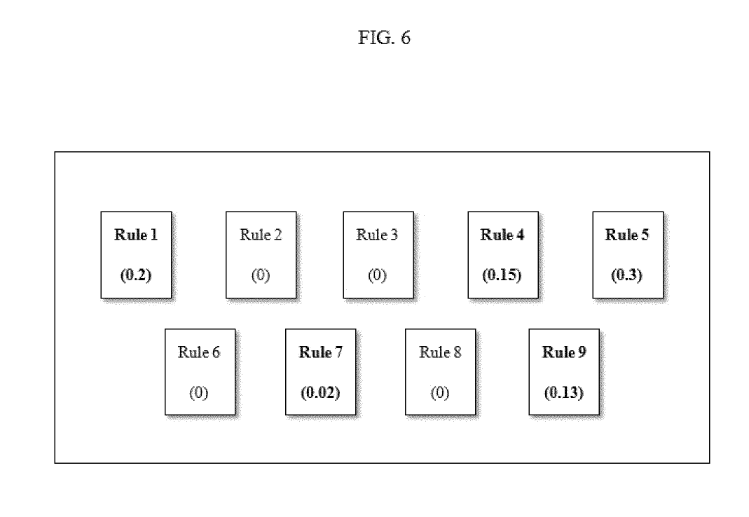

FIG. 6 is an exemplary diagram illustrating a probability that the data service engine 106 for each rule is used in a rule execution process according to an embodiment of the present disclosure. As described above, the data service engine 106 may increase a probability that data related to the corresponding rule is cached in the data service engine 106 as a probability that the data service engine 106 is used during the rule execution process increases, and reduce the probability that data related to the corresponding rule is cached in the data service engine 106 as the probability that the data service engine 106 is used during the rule execution process decreases.

Referring to FIG. 6, probabilities that the data service engine 106 is used when rules 1 to 9 are executed are respectively 0.2, 0, 0, 0.15, 0.3, 0, 0.02, 0, and 0.13, and it can be seen that the probabilities that the data service engine 106 is used when rules 1, 4, 5, and 9 are executed are relatively high. Accordingly, when data related to rules 1, 4, 5, and 9 is cached in the data service engine 106, costs required for the execution of the rules may be relatively minimized. Therefore, according to the embodiments of the present disclosure, the higher the probability that the data service engine 106 is used when the corresponding rule is executed, the higher the probability that data related to the corresponding rule is cached in the data service engine 106.

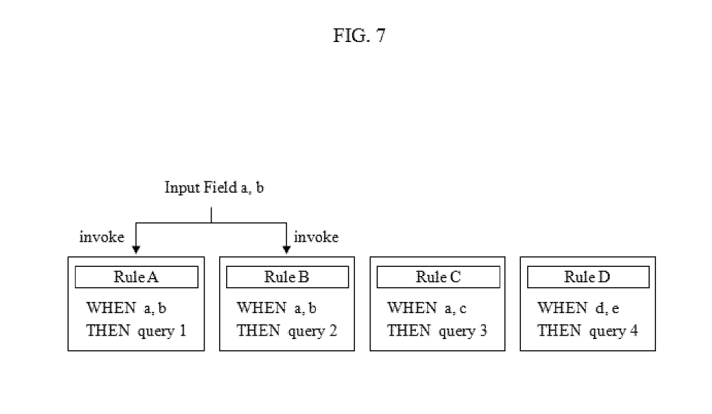

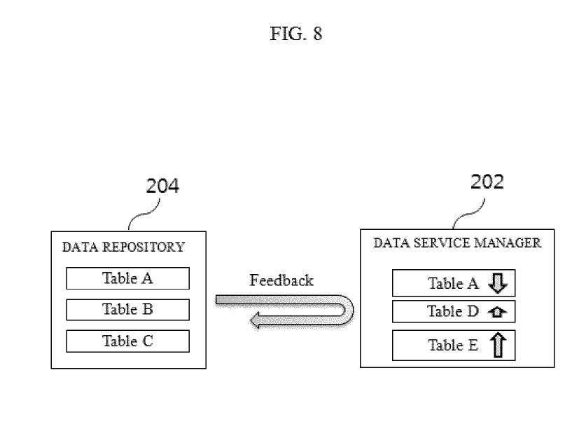

FIG. 7 is an exemplary diagram for explaining a process of caching a part of data in order to minimize costs required for executing a rule in the data service engine 106, and FIG. 8 is an exemplary diagram for explaining a process of updating cached data according to a cache priority for each table in the data service engine 106. The data service engine 106 may determine data cached in the data repository 204 by weighting frequently used data in order to efficiently use limited resources, cache the determined data in the data repository 204, and then perform decision-making through this.

Referring to FIG. 7, the data service engine 106 may determine whether any rule is to be executed by analyzing input data input to the rule engine 102. For example, when input data a and b is input to the rule engine 102, rule A and rule B may be executed. That is, when the input data corresponds to a conditional statement of the corresponding rule, the corresponding rule may be executed.

At this time, the input data a and b may be input to the rule engine 102 in a combination of list types. For example, the input data a and b may be input to the rule engine 102 in the form of [{a1, b1}, {a2, b2}, {a3, b3}, . . . , and {a1000, b1000}]. As a result, when the input data corresponds to a condition of “WHEN”, query 1 and query 2 may be executed 1,000 times each. The data service engine 106 may analyze the rule, and determine query 1 and query 2 as frequently used queries based on the analyzed result. Thus, the data service engine 106 may preferentially cache data related to query 1 and query 2 in the data service engine 106, thereby minimizing costs required for the execution of the rule.

In addition, referring to FIG. 8, frequently used data may vary over time, and the above-described cache priority may also vary over time. The data service manager 202 may recalculate the cache priority for each table at every set time (or periodically), and update the data cached in the data repository 204 according to the recalculated cache priority. For example, when tables currently cached in the data repository 204 are table A, table B, and table C, the data service manager 202 may delete table A cached in the data repository 204 and newly cache table D and table E in the data repository 204 according to the recalculated cache priority.

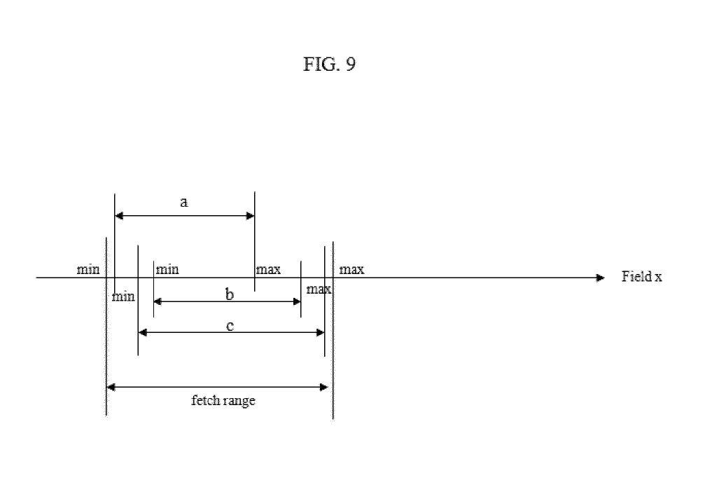

FIG. 9 is an exemplary diagram for explaining a process of optimizing data cached in the data service engine 106. As described above, when there are a plurality of pieces of data to be cached, the data service engine 106 may cache a data area having a range covering all of the plurality of pieces of data. As an example, when the data to be cached is a, b, and c, and a, b, and c respectively have a data area range of a=0<x<50, b=40<x<70, and c=20<x<100, the data service engine 106 may optimize the cached data area by fetching and caching the data area having the range covering all of the plurality of pieces of data, that is, a data area having a range of 0<x<100 at a time. This optimization technique may be applied to data that has been frequently used recently (e.g., data that is used more than a set number of times in the last month). When a request for data outside a range of the optimized data area is required, the rule engine 102 may directly access the DB 154 of the legacy system 150 to collect the data outside the range. The collected data may be used to recalculate the range of the data area.

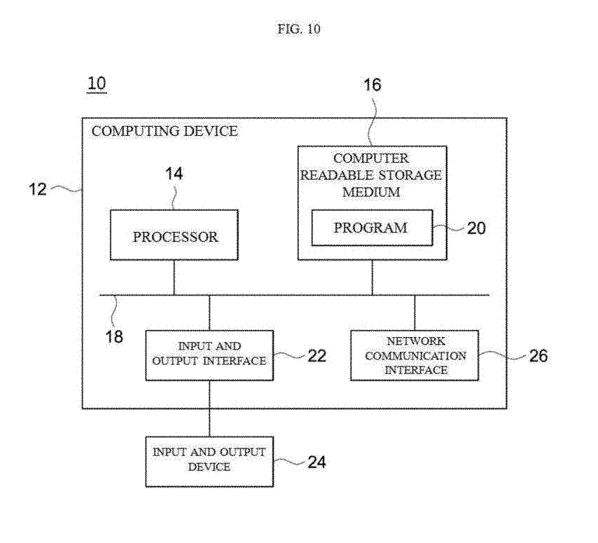

FIG. 10 is a block diagram for illustrating and explaining a computing environment 10 including a computing device suitable for use in exemplary embodiments. In the illustrated embodiment, each component may have different functions and capabilities other than those described below, and additional components in addition to those described below may be provided.

The illustrated computing environment 10 includes a computing device 12. According to one embodiment, the computing device 12 may be the rule engine 102. In addition, the computing device 12 may be the data service engine 106. In addition, the computing device 12 may be the legacy server 152.

The computing device 12 includes at least one processor 14, a computer-readable storage medium 16, and a communication bus 18. The processor 14 may cause the computing device 12 to operate in accordance with the exemplary embodiment discussed above. For example, the processor 14 may execute one or more programs stored in the computer-readable storage medium 16. The one or more programs may include one or more computer-executable instructions, and the computer-executable instructions may be configured to cause the computing device 12 to perform operations in accordance with the exemplary embodiment when they are executed by the processor 14.

The computer-readable storage medium 16 is configured to store the computer-executable instructions or program codes, program data, and/or other suitable forms of information. A program 20 stored in the computer-readable storage medium 16 includes a set of instructions executable by the processor 14. According to one embodiment, the computer-readable storage medium 16 may be a memory (volatile memory such as random access memory, non-volatile memory, or any suitable combination thereof), one or more magnetic disk storage devices, optical disk storage devices, flash memory devices, or other types of storage media that can be accessed by the computing device 12 and store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 may be connected to the communication bus 18. The input/output device 24 may be connected to other components of the computing device 12 via the input/output interface 22. The exemplary input/output device 24 may include input devices such as pointing devices (mouses or trackpads), keyboards, touch input devices (touch pads or touch screens), voice or sound input devices, various types of sensor devices and/or photographing devices, and/or output devices such as display devices, printers, speakers, and/or network cards. The exemplary input/output device 24 may be included within the computing device 12 as one component constituting the computing device 12, or may be coupled to a computing device 12 acting as a separate device distinct from the computing device 12.

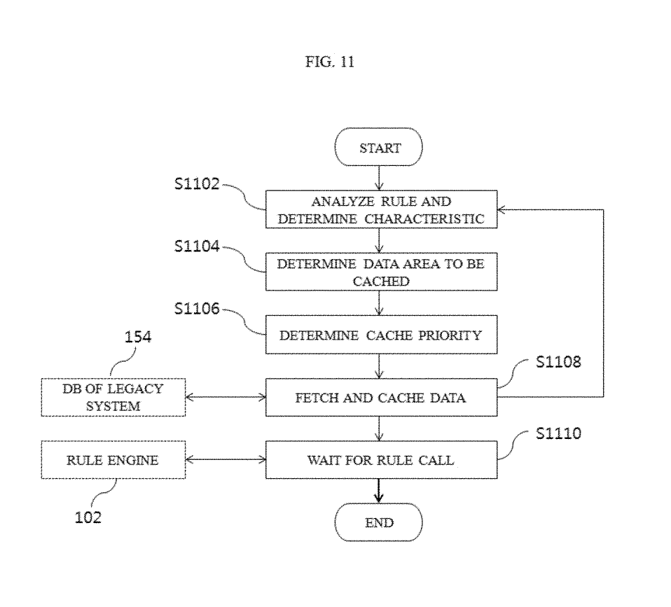

FIG. 11 is a flowchart illustrating a data caching process in the data service engine 106 according to an embodiment of the present disclosure. In the illustrated flowchart, the method is described as being divided into a plurality of operations, but at least some of the operations may be performed in a different order, performed in combination with other operations, omitted, performed in separate operations, or performed with addition of one or more operations not shown.

First, in operation S1102, the data service engine 106 analyzes rules, and determines characteristics of each rule. The data service engine 106 may analyze the rules at every set time (or periodically), and the analysis time or period may vary depending on the number of times the rule is executed, cycles, etc. The data service engine 106 may determine the characteristics of each rule by analyzing, for example, queries, input data, and the like related to the execution of the rule. Here, the characteristics of each rule include a wide meaning including how frequently the corresponding rule is executed, how long it takes to execute the corresponding rule, how many times I/O with the legacy system 150 occurs when the corresponding rule is executed, and the like. As an example, the data service engine 106 may analyze the rules to determine a frequency of execution for each rule.

Next, in operation 51104, the data service engine 106 determines a data area to be cached. Since the size of the data repository 204 of the data service engine 106 is limited, the data service engine 106 may determine only a part of data stored in the DB 154 of the legacy system 150 as data to be cached in accordance with the analysis result. As an example, the data service engine 106 may determine data related to the rule whose execution frequency is equal to or larger than a set value as data to be cached in the data service engine 106. At this time, when there are a plurality of pieces of data to be cached, the data service engine 106 may determine a data area having a range covering all of the plurality of pieces of data as a data area to be cached.

Next, in operation S1106, the data service engine 106 determines a cache priority for each table to which the data area belongs with respect to each data area (or data) to be cached. Here, the cache priority may be determined in consideration of at least one of, for example, a frequency or probability of access for each table, a data manipulation frequency for each table, a data size for each table, a size of the data repository of the data service engine 106, the number of times each rule is executed, an execution time of a query related to the execution of the rule, an execution speed of the query, the number or cycle of calls of the query, and a bandwidth usage while the data service engine 106 is connected to the DB 154.

Next, in operation S1108, the data service engine 106 fetches and caches a part of the data stored in the DB 154 of the legacy system 150 according to the cache priority. As described above, since the data service engine 106 is directly connected to the DB 154 of the legacy system 150, the data service engine 106 may access the DB 154 to fetch required data. In addition, the data service engine 106 may repeatedly perform operations S1102 to S1106 again after fetching and caching the data, thereby continuously updating the data cached in the data service engine 106.

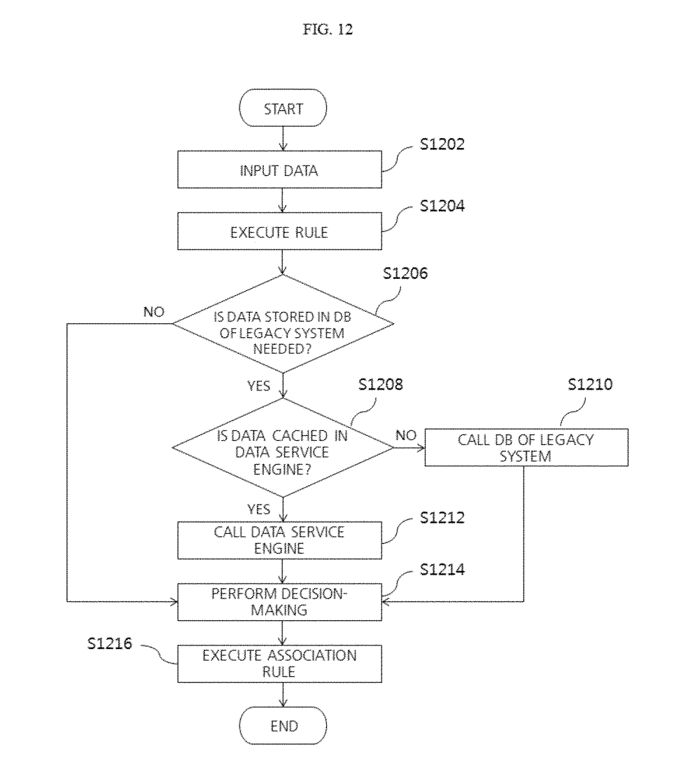

Finally, in operation S1110, the data service engine 106 waits for a rule call from the rule engine 102. A rule processing procedure according to the rule call from the rule engine 102 will be described in detail with reference to FIG. 12.

FIG. 12 is a flowchart for explaining a rule processing procedure according to an embodiment of the present disclosure. In the illustrated flowchart, the method is described as being divided into a plurality of operations, but at least some of the operations may be performed in a different order, performed in combination with other operations, omitted, performed in separate operations, or performed with addition of one or more operations not shown.

First, in operation S1202, input data is input to the rule engine 102.

Next, in operation S1204, the rule engine 102 executes a corresponding rule according to the input data.

Next, in operation S1206, the rule engine 102 determines whether data stored in the DB 154 of the legacy system 150 is needed during a decision-making process according to the execution of the rule. When the data stored in the DB 154 is to be used as an input value or a reference value, the rule engine 102 may determine that the data is needed.

When it is determined that the data stored in the DB 154 of the legacy system 150 is not needed in operation S1206, the rule engine 102 may perform decision-making immediately according to the corresponding rule in operation S1214.

When it is determined that the data stored in the DB 154 of the legacy system 150 is needed in operation S1206, the rule engine 102 determines whether the data is cached in the data service engine 106 in operation S1208.

When it is determined that the data is not cached in the data service engine 106 in operation S1208, the rule engine 102 may retrieve the data by calling the DB 154 of the legacy system 150 through the legacy server 152 in operation S1210. In this case, in operation S1214, the rule engine 102 may access the DB 154 of the legacy system 150 through the legacy server 152, and perform decision-making using the data retrieved from the DB 154.

When it is determined that the data is cached in the data service engine 106 in operation S1208, the rule engine 102 may retrieve the data by directly calling the data service engine 106 in operation S1212. In this case, in operation S1214, the rule engine 102 may perform decision-making using the data cached in the data service engine 106 instead of accessing the DB 154 through the legacy server 152.

In addition, in operation S1216, the rule engine 102 may execute an association rule related to the rule after operation S1214. Here, the association rule means a rule that uses output data of the rule as input data.

According to the embodiments of the present disclosure, the rule engine may perform decision-making using the data cached in the data service engine instead of accessing the DB of the legacy system when the corresponding rule is executed, so that the occurrence of an excessive transaction of the legacy system may be prevented and a load of the legacy system may be reduced, thereby preventing a bottleneck phenomenon that may occur when the corresponding rule is executed.

In addition, according to the embodiments of the present disclosure, the data service engine may calculate costs required for the execution of the rule by analyzing the corresponding rule and cache a part of the data stored in the DB of the legacy system so as to minimize the costs, so that a time required for securing data may be minimized and limited resources of the data service engine may be efficiently used. In this case, the ease of operation of the rule engine may be also improved on the user side, and user intuitiveness may be greatly improved when creating rules.

In addition, according to the embodiments of the present disclosure, the data service engine may determine the cache priority for each table to which data belongs, and determine the data cached in the data service engine according to the cache priority, thereby more efficiently performing data caching.

Meanwhile, the embodiments of the present disclosure may include a program for performing the methods described herein on a computer, and a computer-readable recording medium including the program. The computer-readable recording medium may include program instructions, local data files, local data structures, and the like individually or in a combination. The medium may be specifically designed and constructed for the present disclosure, or may be commonly used in the field of computer software. Examples of the computer-readable recording medium include a magnetic medium such as a hard disk, a floppy disk, or a magnetic tape, an optical recording medium such as a compact disc-read only memory (CD-ROM) or a digital video disc (DVD), a magneto-optical medium such as a floptical disk, and a hardware device such as ROM, a random access memory (RAM), or a flash memory that is specially designed to store and execute program instructions. Examples of the program include not only machine language codes generated by a compiler or the like but also high-level language codes that may be executed by a computer using an interpreter or the like.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. A rule management system comprising:
a processor configured to implement:
a rule engine configured to perform decision-making based on a rule; and
a data service engine configured to connect to a database (DB) of a legacy system, determine data stored in the DB to be cached by analyzing the rule, and cache the determined data,
wherein the rule engine is further configured to perform the decision-making using data cached in the data service engine.

2. The rule management system of claim 1, wherein the data service engine is further configured to determine the data stored in the DB to be cached to minimize costs required for execution of the rule.

3. The rule management system of claim 2, wherein the rule is one of a plurality of rules, and
wherein the data service engine is further configured to determine the data stored in the DB to be cached based on a frequency of execution for each of the plurality of rules.

4. The rule management system of claim 3, wherein the data service engine is further configured to increase a probability that data related to a corresponding rule of the plurality of rules is to be cached in the data service engine as the frequency of execution increases, and reduce the probability that data related to a corresponding rule is to be cached in the data service engine as the frequency of execution decreases.

5. The rule management system of claim 2, wherein the data service engine is further configured to determine a cache priority for each table to which the data belongs, and determine the data stored in the DB to be cached in the data service engine according to the determined cache priority for each table to which the data belongs.

6. The rule management system of claim 5, wherein the cache priority for each table to which the data belongs is determined based on at least one among a frequency or probability of access for each table, a data manipulation frequency for each table, a data size for each table, a size of a data repository of the data service engine, a number of times each of the plurality of rules is executed, an execution time of a query related to execution of the of the plurality of rules, an execution speed of the query, a number or cycle of calls of the query, and a bandwidth usage while the data service engine is connected to the DB.

7. The rule management system of claim 2, wherein the data service engine is further configured to cache a data area having a range covering all of a plurality of pieces of data to be cached.

8. A rule management method comprising:
performing, by a rule engine, decision-making based on a rules;
determining, by a data service engine connected to a DB of a legacy system, data stored in the DB to be cached by analyzing the rule; and
caching the determined data,
wherein the performing includes performing the decision-making using data cached in the data service engine.

9. The rule management method of claim 8, wherein the determining includes determining the data stored in the DB to be cached to minimize costs required for execution of the rule.

10. The rule management method of claim 9, wherein the determining includes determining the data stored in the DB to be cached based on a frequency of execution for each of the plurality of rules.

11. The rule management method of claim 10, wherein the determining includes increasing a probability that data related to a corresponding rule is determined to be cached in the data service engine as the frequency of execution increases, and reducing the probability that data related to a corresponding rule is determined to be cached in the data service engine as the frequency of execution decreases.

12. The rule management method of claim 9, wherein the determining includes determining a cache priority for each table to which the data belongs, and determining the data stored in the DB to be cached in the data service engine according to determine the cache priority for each table to which the data belongs.

13. The rule management method of claim 12, wherein the cache priority for each table to which the data belongs is determined based on at least one among a frequency or probability of access for each table, a data manipulation frequency for each table, a data size for each table, a size of a data repository of the data service engine, a number of times each of the plurality of rules is executed, an execution time of a query related to execution of the plurality of rules, an execution speed of the query, a number or cycle of calls of the query, and a bandwidth usage while the data service engine is connected to the DB.

14. The rule management method of claim 9, wherein the caching includes caching a data area having a range covering all of plurality of pieces of data to be cached.

15. A non-transitory computer readable recording medium having embodied thereon a program, which when executed by a processor of a rule management system, causes the rule management system to execute a rule management method, the rule management method including:
performing, by a rule engine, decision-making based on a rules;
determining, by a data service engine connected to a DB of a legacy system, at least data stored in the DB to be cached by analyzing the rule; and
caching the determined data,
wherein the performing includes performing the decision-making using data cached in the data service engine.

16. The non-transitory computer readable recording medium of claim 15, wherein the determining includes determining the data stored in the DB to be cached to minimize costs required for execution of the rule.

17. The non-transitory computer readable recording medium of claim 16, wherein the determining includes determining the data stored in the DB to be cached based on a frequency of execution for each of the plurality of rules.

18. The non-transitory computer readable recording medium of claim 17, wherein the determining includes increasing a probability that data related to a corresponding rule is determined to be cached in the data service engine as the frequency of execution increases, and reducing the probability that data related to a corresponding rule is determined to be cached in the data service engine as the frequency of execution decreases.

19. The non-transitory computer readable recording medium of claim 16, wherein the determining includes determining a cache priority for each table to which the data belongs, and determining the data stored in the DB to be cached in the data service engine according to determine the cache priority for each table to which the data belongs.

20. The non-transitory computer readable recording medium of claim 19, wherein the cache priority for each table to which the data belongs is determined based on at least one among a frequency or probability of access for each table, a data manipulation frequency for each table, a data size for each table, a size of a data repository of the data service engine, a number of times each of the plurality of rules is executed, an execution time of a query related to execution of the plurality of rules, an execution speed of the query, a number or cycle of calls of the query, and a bandwidth usage while the data service engine is connected to the DB.
